(19) United States
(12) Patent Application Publication
(10) Pub. No.: US 2017/0060893 A1
(43) Pub. Date: Mar. 2, 2017

(54) TRANSLATING FILE TYPE AWARE VIRTUAL FILESYSTEM AND CONTENT ADDRESSABLE GLOBALLY DISTRIBUTED FILESYSTEM

(71) Applicant: Xcube Research and Development, Inc., Nashua, NH (US)

(72) Inventors: Mikael B. Taveniku, Nashua, NH (US); Joseph Trier, Henniker, NH (US)

(21) Appl. No.: 15/247,864

(22) Filed: Aug. 25, 2016

Related U.S. Application Data
(60) Provisional application No. 62/283,213, filed on Aug. 25, 2015.

(51) Int. Cl. G06F 17/30

(52) U.S. Cl. CPC G06F 17/30106; G06F 17/30126; G06F 17/30112; G06F 17/30076; G06F 17/30233

(57) ABSTRACT

This invention provides a file system for organizing files in a data processing and handling device. A set of annotations signifying locations or time in files are provided. A search process combines annotations and intervals together into a final result. A user interface is operatively connected to the device that allows the user to enter requests and data. Illustratively, the user requests the intervals in files that corresponds to a search criteria and the search process searches through the annotations and combines them to find the intervals in files or groups of files where the condition is true, and the intervals of the found files are arranged to be displayed to the user on the interface.

### RELATED APPLICATIONS

This application claims the benefit of U.S. Provisional Application Ser. No. 62/283,213, filed Aug. 25, 2015, entitled PATENT VFS, the entire disclosure of which is herein incorporated by reference.

### FIELD OF THE INVENTION

This invention relates to management of large sets of files, ability to find data of interest inside files and sets of files, filesystems, distributed data sets, distributed computing, streaming data, such as video or sensor data, and management of “big” streaming data as well as combining content addressability, multiple datasets in a manner free of copy, inclusion of a scheduler for desktop acceleration, and reformatting of data.

### BACKGROUND OF THE INVENTION

Modern storage systems consist of file servers, filesystem drivers, disc controllers and associated disks. The storage units store the data without (free of) explicit knowledge about what they are storing, simply storing a stream of bytes (or similar) with potentially generic compression. This can pose challenges to the proper storage and handling of files within a high-volume storage environment. By way of useful background information, commonly assigned U.S. patent application Ser. No. 13/625,553, entitled SYSTEM AND METHOD FOR HIGHSPEED DATA RECORDING, filed Sep. 24, 2012, the teachings of which are incorporated herein by reference, provides an array of disks interconnected controlled by a scheduler that allows for a mass inflow of stored data. The scheduler assembles and directs streaming write of data packets to each of the disks across the array at a high speed as disks become available to receive the data packets. A control computer is provided, and includes an operating system and a file system that interacts with the scheduler. The presence of such large data streams makes it desirable to provide a file system capable of handling specific file types.

### SUMMARY OF THE INVENTION

This invention provides a filesystem that uses knowledge about files such as file format, time or frame information, or other content of the files, to provide specific compression, file cutting, file translation, multiple file format presentation, file protection, decrease network traffic, and potentially optimize performance. The Enhanced File System can be used to decouple the stored file format from the presented file format(s), and in an extension provide a way for users to do custom file translation on the fly, as well as provide “cut” ability to enable portions of a larger file or file-set to be presented as new, smaller files, and in an extension enable content addressable storage by combining annotations and cut ability.

This invention can also provide a content addressable (globally) distributed filesystem that can solve the challenge of using snippets of large files, where the content inside the files are of interest rather than the file itself. It can extend the concepts of an Object store with a Filesystem gateway to content inside files and groups of files. It also can provide methods to expose only parts of the original files, so that large amounts of data is not moved. It can also move the applications to the data, and by doing so, can significantly reduce the network traffic, and enable applications to operate on remote servers with limited network bandwidth. Combining the distributed content addressable filesystem with the virtual machine concept and remote execution enables non-modified (or slightly modified) desktop applications to run in parallel across a globally distributed set of servers without any user level programming.

In an illustrative embodiment, a file system for organizing files in a data processing and handling device is provided. A set of annotations signifying locations or time in files is provided. A search process combines annotations and intervals together into a final result. A user interface, operatively connected to the device, allows the user to enter requests and data. The user requests the intervals in files that correspond to one or more search criteria. The search process searches through the annotations and combines them to find the intervals in files or groups of files where the condition is true, and the intervals of the found files are arranged to be displayed to the user on the interface. Illustratively, the data processing and handling device can comprise a distributed content addressable storage arrangement and the storage arrangement comprises a plurality of storage servers. The storage servers can be constructed and arranged to perform a data distribution and collection function. The data distribution function can receive the request from the user and distribute it to participating storage nodes, wherein the storage nodes search for the results with the search process and return the results to the collection function, in which the results are presented to the user via the user interface. The files displayed are by software separated from the format they are stored in components in which the translation layer has knowledge of certain file types, and can translate from one type of file to another type of file. Illustratively, the translation can be made using a fixed translation scheme. In an embodiment, the files stored in a first format (A) are presented to the user in a second format (B). The files can be presented as a subset of the original file, and translated or transformed to be a valid file comprising of the subset requested in the same or a different format or formats. This can include: (a) components and a process for determining the start and end of the subset of the files or sets of files where a start and end index, time, location, marker or other process are defined by an outside process; (b) translation layer reads the original file(s) and creates a new virtual file based on this information; and (c) the virtual file is a window and not the whole file, whereby the user is presented with a smaller virtual copy of the original file or files comprising of the interval requested, and whereby the whole files and their format need not be known, or moved, and they are protected from the user. Illustratively, the system is arranged to cut a file and then present a virtual smaller file to the user. This can include: (a) original files on stored media; (b) a reader and translation layer that has knowledge as to how to read write and access the original files; (c) a process of transforming the portion of the file into a new valid smaller (shorter) and/or different file; and (d) a presentation filesystem that the user can access to the new virtual file, wherein the original files are protected and hidden from the user and the user can work on only a particular portion of the files in potentially in different file formats enabling the user application to work independent of the stored format as well as only on portions of the actual files.

In another illustrative embodiment, a system is provided for accessing as a file a resulting file derived from a one or plurality of other files in which more than one file is used to produce an output file that the user can view. One or more storage devices that contain(s) the files used to construct the requested file are also provided. A software layer concatenates combines and/or translates the file into the appropriate format for the end application. A user filesystem presentation layer presents the resulting file to the user, wherein this layer can be, but is not limited to FUSE, wherein the user operates on a derived file based on one or more concatenated or combined files while leaving/retaining original data on the storage system. Illustratively, the stored files are of a controller area network (CAN bus) type, and one or more of the files contain the CAN database data describing what the messages mean and the system provides as an output the combined and decoded CAN messages to the application whereby the application is free of knowledge as to how to translate and filter the CAN messages and as to the format they are stored in. The application can comprises a commercially available package, such as the well-know MatLab® software package available from MathWorks, Inc. of Natick, Mass..

In another illustrative embodiment, a system for accessing portions of files or file sets based on intervals determined by an outside process is provided. This system includes original files on a storage system and a translator that can cut files of known types based on an interval criteria. The translator has knowledge as to how to read an appropriate interval of data from the original files and/or can recreate a new, potentially smaller file with the appropriate header information based on the requested file format and interval. The translator can be arranged to combine a plurality of files into the resulting file and/or to output a plurality of different formats concurrently. Illustratively, a process can be provided, for inputting to the translation layer the interval of interest for example start and end time of a recording. A presentation layer can also be provided, which presents the resulting file-system, file or file-set to the user, wherein the user layer software views a set of files containing only the area of interest and in the formats requested enabling greater efficiency and standard applications to be used.

In another illustrative embodiment, a system for accessing files stored on a computer filesystem separated from the stored files and accessed in one or a plurality of discrete formats that can differ from the stored format is provided. The system includes a filesystem interface for access of the file(s). A translation layer separates the stored files from the presented files. A set of files stored on a media local or remote storage system is managed by the translation layer to be combined, concatenated, translated or in any other process modified or buffered before the resulting file(s) is shown to the user filesystem. The files are presented to a user in a predetermined format as a combination, concatenation, or passed through by the translation layer software, thereby creating a separation of stored files and presented files for an application enabling cutting, translation and concatenation before the user accesses the file.

### BRIEF DESCRIPTION OF THE DRAWINGS

FIG. 1A is a block diagram showing a data file system according to the prior art;

FIG. 1B is a block diagram showing a data file system with a translation layer between the disk and the user application, according to an embodiment; FIG. 2A is a block diagram showing a one-to-one mapping of files on a disk as files available to a user, according to the prior art;

FIG. 2B is a block diagram showing one-to-one and one-to-many mapping of files on a disk as files available to a user, according to an embodiment;

FIG. 3 is a block diagram showing a method for providing a translation of files, according to an embodiment;

FIG. 4A is a block diagram showing an Enhanced File System being used to combine information from two files to produce a third file, according to an embodiment;

FIG. 4B is a block diagram showing an Enhanced File System using information from a database to create a virtual file, according to an embodiment;

FIG. 4C is a block diagram showing an Enhanced File System being used to combine information from a database and information from a separate file to produce a single output file, according to an embodiment;

FIG. 5 is a block diagram showing the cutting and translating of a file by an Enhanced File System, according to an embodiment;

FIG. 6A is a block diagram showing a static mapping by the Virtual File System, according to an embodiment;

FIG. 6B is a block diagram showing a translational mapping by the Virtual File System, according to an embodiment;

FIG. 6C is a block diagram showing a dynamic mapping based on an external application sending messages or control information to the Virtual File System to set up or modify mappings or translations, according to an embodiment;

FIG. 7 is a block diagram showing a Virtual File System accessing remote files on one server and presenting virtual files on a second server to a user, according to an embodiment;

FIG. 8 Is a data-flow diagram showing how annotations based on intervals in a file or set of files can be used to come up with a final content addressed part of the file or set of files, according to an embodiment;

FIG. 9 is a block diagram showing a distributed search for content addressable filesystem, according to an embodiment;

FIG. 10 is a block diagram showing an example of result sets of the distributed search of FIG. 9, according to an embodiment; and

FIG. 11 is a block diagram showing an example of how the result sets of FIG. 10 are used in a distributed global setting, according to an embodiment.

### DETAILED DESCRIPTION

In many applications that handle large files it is not feasible to move entire file content across networks. It is also the case that in many applications a large file, such as a telemetry file from a sensor array, video surveillance file or a set of video from sporting events, only small instances of the actual file is of interest to a user. This “area” or “interval” of interest can be defined by some criteria that the user is interested in, for example a position of a quarterback, or the presence of pedestrians and rain, or a sensor reporting an error. It is also the case that in many applications the user would like to use one storage format, while applications may be enabled to access files on one or more different formats. Several applications can benefit from file-type-specific compression of the file, while still being able to provide it transparently to the user applications. Additionally it is sometimes desirable to provide read and write ability for applications while still protecting the original data (without (free of) making copies). The illustrative embodiments herein address each of those challenges by using a translation layer between the normal, device-layer filesystem and the user access filesystem.

This patent describes a filesystem that retains knowledge/context (“knows”) about specific file types that it is storing. It can therefore provide specific treatment of those files. This process can then be used to address multiple challenges such as providing file translation on the fly so files can be stored in one format and then presented in one or many different formats. This enables the files to use the latest compression technology, while the user applications do not require knowledge as to how it is stored. It also enables a file to be displayed to a user in multiple formats, or a set of files to be combined and processed then potentially presented as one or many files. This can disconnect the actual files stored from the way those files are displayed. In addition this scheme can be used to provide virtual “cut” portions of larger files, so that user applications can work on small parts of larger files, thus significantly reduce network traffic and complexity of the applications. In addition the ability to provide custom “user defined” translations can enable, for example sensor developers to store data in proprietary formats, while using off the shelf tools for using the files in standard, or well-known formats. By way of non-limiting example, a new image sensor can produce raw pixel data in a proprietary format, this data can then be lossless, compressed to be stored on disk, while the applications can get the data as motion .jpg, .avi, or simply images, without (free of) copying any files on disk.

The embodiments can decouple the user level view of the filesystem from the stored files. In an embodiment, the system uses the Filesystem in User Space (FUSE) filesystem arrangement for the presentation layer and implements the reader, writer, and translation layers. This is one possible embodiment, among many.

The process of storing and retrieving files can be changed from the traditional Operating system—Filesystem—Filesystem driver via a connection to disks, so that a layer of software can be inserted between the User Level Filesystem access layer and the Filesystem used.

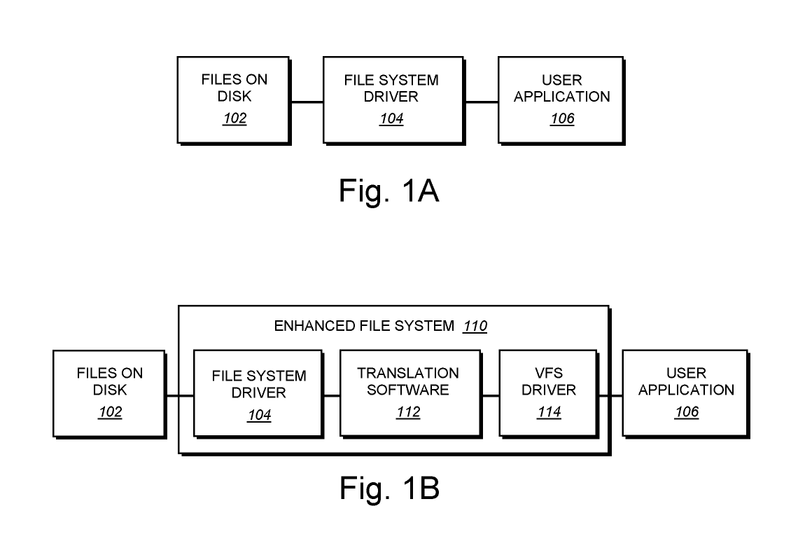

FIG. 1A is a block diagram showing a data file system that is arranged generally according to the prior art. The data file system 100 for a computer can include the access to files on disk 102 through the use of a traditional file system driver 104. This file system driver 104 presents the files on disk 102 to the user application 106 as a series of data without any translation.

FIG. 1B is a block diagram showing an Enhanced File System (EFS) with a translation software layer between the files on disk and the user application, according to an embodiment. The EFS 110 can be created between the actual Filesystem (or extend the Filesystem) so that it can provide a translation between the actual files on disk 102 and the view of those files that is presented to the user application 106. The EFS 110 can include the file system driver 104, a translation software layer 112, and a Virtual File System (VFS) driver 114. The files on disk 102 can be accessed by the file system driver 104. The translation software 112 can then provide a translation of the actual files on disk 102 to the VFS Driver 114. The VFS driver 114 can then present the translated files to the user application 106 as a Virtual File System (VFS). Thus, a virtual filesystem can be presented to the user, and a normal filesystem can be used to store the files. The cut, find, and translate, and virtual copy of the file can be provided inside the EFS 110.

### One-to-One and One-to-Many

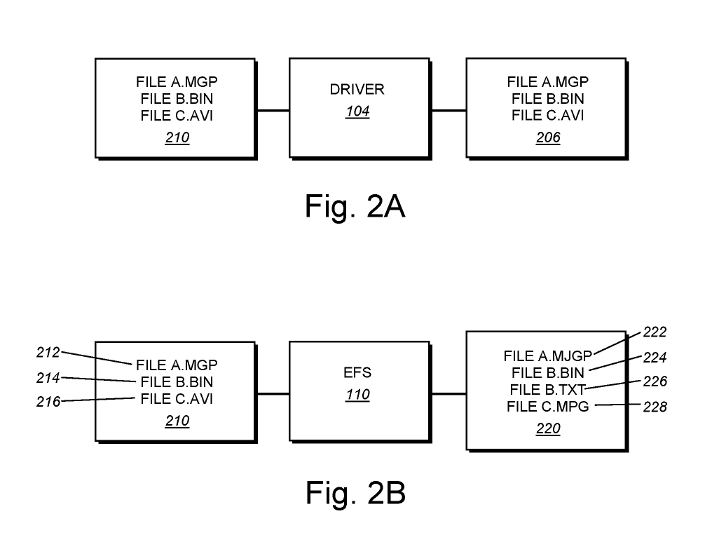

FIG. 2A is a block diagram showing a one-to-one mapping of files on a disk as files available to a user, according to the prior art. The stored files 210 on the disk are accessed by the file system driver 104, and can be presented by the file system driver 104 to the user application 106 (not shown) as available files 206. The files presented as available files 206 are the same files and the same file types as the stored files 210.

FIG. 2B is a block diagram showing one-to-one and one-to-many mapping of files on a disk as files available to a user, according to an embodiment. With the EFS 110, a “virtual file system” can be provided that can present available files 220 from one or many locations in potentially a different format or formats, or multiples, or partials, to the user. Stored files on disk can be presented to the user one-to-one, or can be presented one-to-many. The EFS 110 can process the stored files 210 and present them to the user application 106 as available file 220. The stored files 210 can be accessed by a file system driver 104 (not shown), the files can be translated by translation software 112 (not shown) into available files 220 that can be provided to the VFS driver 114 (not shown), and the available files 220 can be presented by the VFS driver 114 (not shown) to the user application 106. In the translation software layer 112 different methods/techniques can be applied to the files based on their content. For example, a file of type MPEG-4 can be processed and presented as a file of type MOV or something else suitable. By way of non-limiting example, a first stored file 212 can be FileA.MGP, and can be translated one-to-one by the EFS 110 to available file 222 that can be FileA.MJPG. A second stored file 214 can be FileB.bin, and can be translated one-to-many by the EFS 110 to available file 224 that can be FileB.BIN and also to available file 226 that can be FileB.TXT. A third stored file 216 can be FileC.AVI and can be translated one-to-one by the EFS 110 to available file 228 that can be FileC.MPG. Stored files can be from one or many places, and can be translated to a different file type or to multiple different file types.

### Read/Write Process

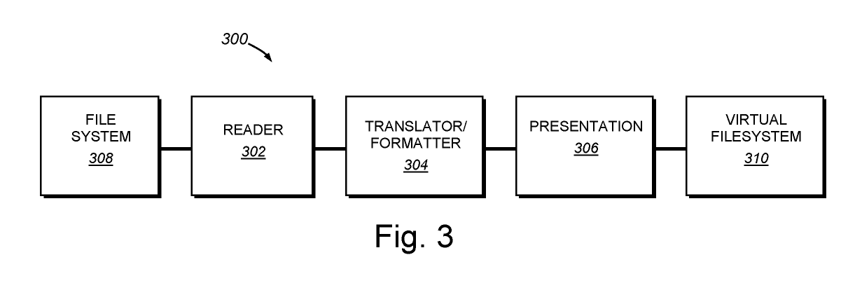

FIG. 3 is a block diagram showing a method for providing a translation of files, according to an embodiment. This process of providing a translation 300 can consist of a Reader 302, a Translator or Formatter 304 and a Presentation (output) application 306. The reader 302 can read and write to the native file on the physical disk's file system 308 using the appropriate access methods. The formatter 304 can translate the native file from the native format to the desired format of the user level file. The formatter 304 can provide the translations from a native data format A to a data format B which can be the same or many different output formats. The presentation application 306 can keep a cache of the output file from the formatter 304 in memory and can provide appropriate methods for the Virtual File System (VFS) driver to present the new “virtual” file to the user application 206. The presentation application 306 can provide the output formatting and can provide the virtual files to the Virtual File System 310 or to the User Application 206. If the native file is writable then the presentation layer 306 can send write back requests backwards through the formatter 304 and reader 302 to the file system 308, reversing the process back to the original file. The reader 302 can be responsible to handle the actual read and writes to the physical file on the physical side of the filesystem. A control process (which can be part of the translation software layer) can, for each file type, directory structure, and so on, select the appropriate Reader, Translator, Presenter combinations for each task, requested file, and the actual stored file. From the user side of the virtual file system (VFS) side, the file looks and feels like a normal file of the requested format. There are several additional features of this file that can be implemented as we describe later.

In the illustrative embodiment, the reader 302 can use the Linux operating system and its standard Filesystem driver for the native files. In alternate embodiments, other types of filesystem, such as CIF, NFS, NTFS or HFS etc. can be used in a manner clear to those of skill. The presentation layer 306 can use the FUSE implementation (File system in User Space) to provide the translated Filesystem to the user. Alternate embodiments can use a true Filesystem driver in a Linux/Unix environment or a Stackable Filesystem driver in the Windows domain.

The FUSE implementation can allow user space code to be used in the reader and translation layers which can significantly decrease implementation complexity as well as allows virtualized file access to databases. Using a driver structure requires the user space functions to be called through a reverse service interface to the driver. This is a well-known technique that can be implemented to allow driver code to employ user space services, and not described here.

### Many-to-One File Mapping

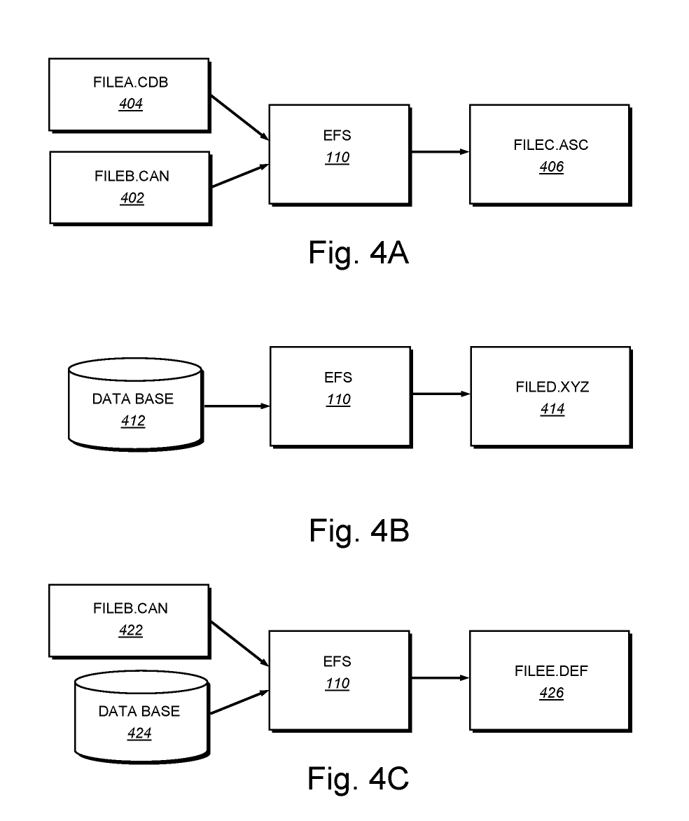

FIG. 4A is a block diagram showing an Enhanced File System being used to combine information from two files to produce a third file, according to an embodiment. In addition to the “one-to-one” and “one-to-many” format mapping it is also possible to do additional functions such as combining several files to a single file. One example of this could be to concatenate multiple small video files to one long recording while addressing redundancy in overlapping sections. In an illustrative embodiment, two or more different files can be combined (concatenated) to create a third type of file. By way of non-limiting example, a Control Area Network (CAN) file 402 of raw packet data can be combined with the CAN data base (cdb) file 404 (a description file on what the packets mean) to create a translated stream of data that can be presented by the EFS 110 as an output file 406 in a CAN ASC format. In this process the software can read information from multiple locations 402, 404 with potentially different types of data to build the output file 406. In this illustrative example of the process of using multiple different input files to produce a different output file, there is no restriction for any or all of the files to be of the same type. More than one file can be used to produce the output file that the user views.

FIG. 4B is a block diagram showing an Enhanced File System using information from a database to create a virtual file, according to an embodiment. By way of non-limiting example, multiple small video files in a database 412 can be concatenated by the EFS 110 to one long recording with overlapping sections removed. This long recording can be provided as a single output file 414.

FIG. 4C is a block diagram showing an Enhanced File System being used to combine information from a database and information from a separate file to produce a single output file, according to an embodiment. File 422 can be combined with information from the database 424 by the EFS 110 to create a single output file 426 that can then be presented to a user application.

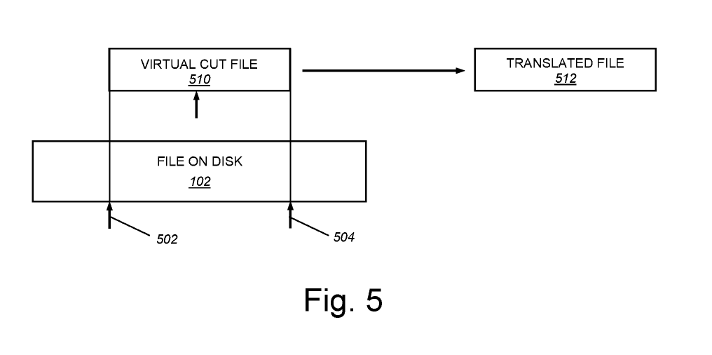

FIG. 5 is a block diagram showing the cutting and translating of a file by an Enhanced File System, according to an embodiment. The “cut” and present functionality provides a way of using only portions of a file, or set of files. This functionality can be combined with all other techniques described here. By way of non-limiting example, the cut and present functionality can be used when the translation software layer is provided a filter, based on, for example, markers, to use an interval of the original file (or file-set) and then provide a file(s) based on that interval. The EFS can get a start marker 502 and an end marker 504 for a File on Disk 102, for example in a File or through an API call that defines the start and end in the original file. The reader can create a virtual cut file 510 from the File on Disk 102 using the start marker 502 and end marker 504. The virtual cut file 510 can be translated and presented to the user as translated file 512.

In many cases this can also require additional operations on the file, such as creating a new file header and trailer, and for, files such as MPEG4 files recreating a code table and reference frames. All of these operations can be done inside the translation software layer. From an implementation perspective the system need to know how to cut and translate each type of file the system supports. This process that a file-type specific translator and cutter need to be provided for each supported file-type. This software module then knows how to recreate a smaller version of the larger file. The process for this can be file-type specific, but in general it can involve creating a new header, a new length of the file, recreating code tables, etc. By way of non-limiting example, for an H264-AV file this process can be illustrated by first getting the most recent code table, finding the most resent reference frame, then recreating a new header with this information in the new file.

The start marker 502 and end marker 504 can be either based on location in the file, or another appropriate indexing method dependent on the application. The important property is that the reader 302 (custom for this file type, or generic) knows how to get to the start and end of the desired subset of the file and recreate any required header and footer information for it. The process of translation and presentation can now progress as described above. Various examples of start marker 502 and end marker 504 can be the “frame number” in a video file, the time in a time indexed file, or simply the location in the file. It is also possible to have approximate locations. A policy, or software option, can instruct the reader 302 how to go to the nearest reasonable point in the file and proceed from there. By way of non-limiting example, in a video file each frame can come at 33 ms intervals, and the marker can be in between two frames In this example, the file start can be at either the previous frame or the next frame depending on the current policy.

### Configurability

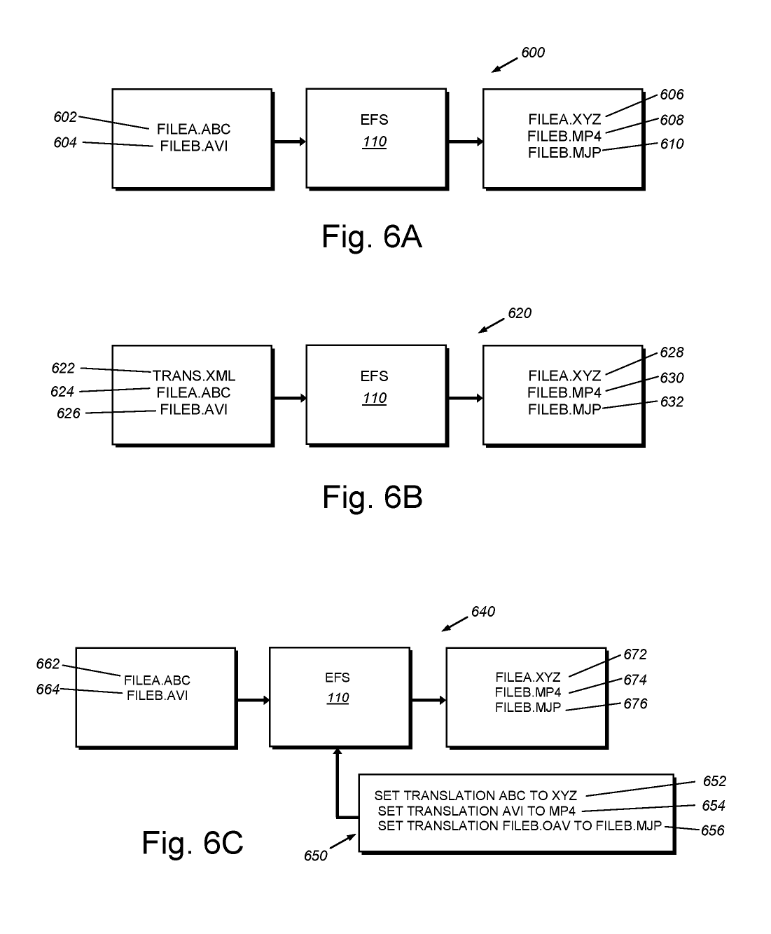

Different translations (in all aspects described previously) can be selected on a file by file, directory or set of files basis. FIG. 6A is a block diagram showing a static mapping by the Enhanced File System, according to an embodiment. In the static mapping 600, there can be a configuration that globally sets what translations the EFS shall do for specific files or file types. In other words, there is a static mapping as defined by internal rules or configuration of the EFS software. The EFS 110 can read files 602 and 604 and can translate them into specific files 606, 608, and 610 according to static rules.

However, in many cases there are specific translations that are needed based on individual groups of files, or some custom action needs to be taken based on a directory, project or special file. FIG. 6B is a block diagram showing a translational mapping by the Enhanced File System, according to an embodiment. In the translational mapping 620, there can be a directory or project based configuration of translation, through a translation description file, which describes what to do for this subset of files or directories. Descriptive information of custom translations can be stored in a file (in our initial embodiment and typically an XML description). When the EFS encounters these known files the behavior of the EFS changes to accommodate the specifics of the configuration file. For example, there can be a file or files that describe the content of the file-set and how that is to be translated. This is similar to how a software version control system works, but here the concept is extended to define file translations and potentially content of the files. In this embodiment the EFS finds the description file 622, then parses it to know what it is supposed to do with this specific file-set containing files 624 and 626 and then modifies its behavior based on the information stored in the description file 622, and presents output files 628, 630, and 632.

Another way to setup translations can be through a dynamic interface. FIG. 6C is a block diagram showing a dynamic mapping based on an external application sending messages or control information to the Virtual File System to set up or modify mappings or translations, according to an embodiment. Dynamic mapping 640 can change based on instructions. Using a control interface, using for example a socket, and listening for instruction messages 650, the EFS 110 can set up translations dynamically to accommodate custom mappings in real-time. By way of non-limiting example, EFS 110 can receive instruction messages 650, including message 652 “set translation abc to xyz,” message 654 “Set defaults .avi to .mp4,” and message 656 “set translation FileB.avi to FileB.mjp.” EFS 110 can then translate input file 662, FileA.abc, to output file 672, FileA.xyz, based on message 652, “set translation abc to xyz.” EFS 110 can translate input file 664, FileB.avi to output file 674, FileB.mp4 based on massage 654, “set translation abc to xyz.” EFS 110 can translate input file 664, FileB.avi, to output file 676, FileB.mjp, based on message 656, “set translation FileB.avi to FileB.mjp.” By using this method, the EFS can operate dynamically and change its behavior based on an external control. By way of non-limiting example, this can be used to provide well-known mount points for use in applications, while the actual content in those mount points change dynamically based on content the user is interested in, or other control processes. By way of non-limiting example, a user can be interested in video sequences where “There is a football game, the quarterback scores, and it is raining,” and the system can mount these sequences in a known location say “/mnt/vfs/results/ <files>” regardless of where the actual files reside.

Another non-limiting example of a possible use can occur as follows: A set of video files from an automotive advanced driver assist system measurement set might contain streams from a forward looking camera, a side-looking camera, and a rear looking camera. These files may contain an object of interest at different times and may need to be treated differently. The translation layer can select the appropriate files to represent each of the streams, the appropriate files each containing the desired content, and present those files appropriately. An alternative method can be using a settings file, described earlier, for the system, or locally for the file-set in question, that provides information to the translator how it shall behave instead of the default translations. In an alternate example, the translator can be provided with this information in run time. This method is more flexible and can be used dynamically to create a VFS as well as make run-time decisions on how to present the files.

All of the methods and examples can be combined to create a hybrid approach in any combination to provide the appropriate functionality.

### Access and Caching Advantages

With the separation of the presentation layer and the physical layer additional advantages can be gained. For example it is possible to provide virtual write capabilities to a file with full protection of the original data by either caching the writes in a “ram” disk area or writes can be done to a file in a different location without affecting the original data. The process can work as follows: The readers can set up the original (protected file) window to the EFS (and the files can be translated if needed), the write path from the users code to the VFS can be redirected to RAM only, or to a different file, or simply disregarded, depending on application needs, and system policy. For the write to different location the software layer can provide a working copy of the original file to this location as accesses progresses. It is not necessary to provide a copy of the original data, but instead the VFS can keep track of only the parts that are changed. If a copy back or write-back to the original file is requested this can be done in the background without user performance degradation. This provides significant performance advantages, especially for network, or remote, filesystems. By intercepting the writes, the VFS can guarantee file protection but still, if needed, show the file as read/write to the application. In this process there is a possibility to only copy data when it is actually needed as opposed to moving larger files.

With the knowledge of the files there is a possibility to only move data when it is actually needed as opposed to moving large files. With the separation of Physical files and Presentation this method can also be used for remote files and in such cases, be used to optimize networked, or remote file accesses. When the EFS is using remote files the reader can ensure large contiguous reads and writes, while the Presentation layer of the VFS maintains a large window of the translated file to where the user level accesses are done. The reader—translator—present combination can cooperate in keeping the cached portion of the file optimizing accesses on both sides. With this method, file accesses can be optimized based on the application and file type behavior as opposed to a generic algorithm as is commonly used. Even the default behavior, with reading large chunks of the files and then working on them in a VFS locally without knowledge of the specifics can significantly improve performance over standard file-caching schemes.

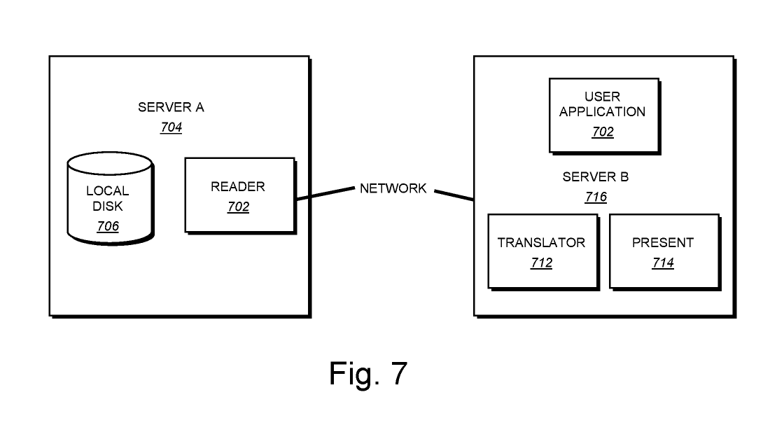

FIG. 7 is a block diagram showing an Enhanced File System accessing remote files on one server and presenting virtual files on a second server to a user, according to an embodiment. The EFS Reader 702, located on Server A 704 handles reads on the remote system making large continuous reads from the database 706, and writes, if enabled. The translator 712 and the presentation layer 714 can be located on Server B 716, along with the user application 718. The user application 718 operates on a virtual file in RAM on Server B 716, to get high performance and minimize network and remote disk overhead. The local user application 712 has fast file access to the local part of the remote file due to the presentation layer 714 keeping a “large” window of the (translated) file in local memory. The reader—translator present combination cooperates in keeping the cached portion of the file optimizing access on both sides. Since the filesystem “knows” about individual file and file-types the window of caching can be tuned to the file and the specific access patterns of the applications. This file-specific tuning creates advantages compared to generic file-caching schemes. In addition the changes (if write is enabled) can be written back to the original file.

### Filters Based on Time, Frame or Other Information Designating Locations in Files or Groups of Files

In one implementation of the EFS it is possible to make only a portion of the file visible to the user. This can be achieved by providing a start and end time, a time span or a frame span, or other marker information to define an interval in the file or file-set. For example a long movie can be presented from t=200 to t=500 seconds as a 300 second long movie. The translation layer can reformat the output file to contain only the 300 seconds of data requested. The concept can also be extended to use the same markers to apply to all or a selection of files in a directory or directories. By using this method, information from this selected interval is consistent across the displayed files. This is especially useful when looking at multiple streams of measurement data and the user is interested in a particular time span in the set of streams. As an extension to the previous sample, there might be additional files associated with the movie, for example an editorial commentary, and perhaps other camera angles, etc. In this case they all can be cut and displayed in the same time interval t=200 to t=500.

This “cut” concept can be extended to use other markers and markers that are combined across multiple files by simply using logical combinations of intervals defined by the markers. The markers, stored for example in a separate database (or set of databases), can be searched and combined to form a resulting (set of) interval(s) that the filesystem can use. By doing so it is not necessarily true that the start and end marker refers to the same file in the file-set, but the process described earlier can be used to find appropriate start and end positions in each file. In this implementation it is important to note that the notion of knowledge of how to treat the file is important. In most cases it is not enough to simply cut a file from the disk. The reason for this is that many files formats have header and footer information as well as internal structure. For example a MPEG file has a header section describing the contents of the file, it then also has internal structure with reference frames and intermediate frames, code tables and other information. In our system the reader and translation portion of the EFS can be responsible for creating the appropriate information to the user layers.

### TAGs and Generic Annotations

This EFS concept can be extended to use generic annotations and markers for the files as a base for how to process, slice or filter the files. In this case markers define intervals and locations in the files. These markers can now be combined to provide one or more criteria for how the translation layer of the enhanced file system should translate and filter the files.

The EFS can be combined with a “search” engine that can find data of interests across a single file, a directory, a computer, or a network of computers, and as a result provide input to the VFS. The EFS can make the appropriate mapping from the data stored in the computer systems to “files of interest” that the user is looking for. The TAG combines intervals in one or many files to a composite interval. The annotations, in one or many files, are combined by the search algorithm to a composite interval that the VFS then uses to cut the file(s) into appropriate segments and then finally present the file or file-set(s). This extension can be called a content addressable Filesystem, where the user visible files are selected based on “their internal content(s) and combination of criteria”.

The process for a content addressable filesystem can be as follows: A user defines criteria to look for (video data, (that has) grey car, (it is) snowing, in Boston), Then the system finds the data based on a database lookup, and then the system sets up the VFS with the appropriate files in a virtual filesystem. Users can now access the data requested in a well-known location.

### Split VFS Implementation

The issue of efficient transfer of data over computer networks is inherently slow and costly. Existing applications do not take network file latency and optimizing file accesses into account. This can limit performance on local disk systems and is very costly on a networked Filesystem. Network file system drivers (and regular file system drivers) try to hide some latency by keeping a portion of the file cached and using techniques such as read ahead and delayed writes.

As an alternative the EFS implementation can be used in “split” mode where the reader portion knows about the nature of the file being retrieved and perhaps more information about the file itself. The EFS can now read appropriate, file specific, portions of the file into its virtual Filesystem using appropriate file and access patterns, reads optimizing the network access and large raid file system needs, while giving the local file RAM filesystem performance. This system can be used in combination with all previously mentioned techniques for the VFS, but with this scheme and the knowledge of the remote nature of the files, significantly improves networked file accesses.

As another application, there is a possibility for a user or application level reader to optimize accesses depending on file properties, or even expected application behavior. Combined with the “cut” and “translate” and “write protect or write only local” capabilities, this significantly reduces need for file transfers to disk or large data movements.

### Use as a Video Storage Server

There are recent advances in video compression technology, and also a need for files to be presented in multiple different formats. In this embodiment, the EFS can provide translation between the preferred storage format and the user visible Filesystem. When user requests data from a virtual file, the EFS can translate that request to a read and convert of the stored data to provide the user with the appropriate files. When the user issues a write the translation can be performed in the other direction. The system can provide storage for video or image streams that are stored in the system. Storage can be performed by:

File →Virtual disk→compression→storage→compressed file on disk(s). User can view one or more files potentially of different types representing the data available. When the virtual file is accessed the EFS can provide the correct translation module and read data from the stored file. Stored data→translation→virtual file→user access

The video server as well as the distributed video storage with search capabilities is a natural application of the EFS described here. A searchable catalog of annotations can be used to find snippets of files that are of interest, and then the EFS can cut and translate (if appropriate) the files to produce the intervals of interest, regardless of the actual file lengths and location.

### Generic Storage Server Using VFS Technology

The system can be set up with a set of known translations (Read, Translate, and Present) modules. When the user then browses the VFS, the directory listings can show the possible virtual files that can be accessed in that directory. When an actual access to the files is made the preconfigured translator can provide access to the file in the appropriate format. In this way a generic translation between stored and usable file formats can be achieved.

This generic storage server concept can be extended to use Time or frame filters or specific readers as described earlier. A user can browse directories and view the files possible to access. When the users open a file, the appropriate translator module can be called, and the file in appropriate format can be provided to the user.

### Extension by User Code

The above system can be extended to allow user level code to be written to make the translations and/or cutting. In this embodiment the EFS can provide a simple call interface for the user to implement the read, write, view, and stat methods for the reader. Thus, the user level code can implement the methods needed to read and write their file format. In addition there can be a similar interface implemented for the translation layer. The translation layer can contain code that knows how to translate the data produced by the reader code and produce data in the format required by the presentation layer. The presentation layer can be a system level code that operates on the virtual file (data blocks) created by the translation layer code and interface with the user level application code. The presentation layer can get requests from the user application to read and write data that it can read and write in the ram buffers.

The user level code can be designed so that no driver coding is involved, rather user space code can be written using normal read and write methods to the source file system. Optional time or frame filter methods can be provided so that the library of file translators can be extended. In addition to the reader side a similar set of functions can be provided by user level programming in order to provide the translation from the “source” file format to the target file format.

Using these two parts the EFS can be extended by user level coding, obtaining custom Filesystem operation and behavior tuned to user application needs. This is very useful for custom data formats or other applications where one or more potentially custom files or file formats need to be used by a “standard” processing package. Using the custom translation on the fly can remove the need for copying files and cutting original files into smaller ones needed for processing.

### Content Addressable Globally Distributed Filesystem

By way of further background, in the area of streaming data, big streaming data, big distributed streaming data, multi-sensor streaming data, and data stored or produced as streams, there are, multiple challenges concerning finding the right data inside a stream, defining subsets of many instances of data in many streams, using instances of data, combining data with applications, and finally how to be able to use large data distributed across multiple locations. This disclosure addresses these challenges where the unit of access (the thing(s) we are looking for) is not a file, but can be a part of a file or a group of files that belong together. The group can be called a “project” but it can apply to a generic set of files that by a process belong together. A typical non-limiting example would be in video surveillance with hundreds or thousands of cameras. A user may not be not interested in the entire video file from each camera, but can be interested in the instances in (all) the files that has the man with the hoodie and the black backpack. Shipping the entire files is often costly, and finding the instances of interest in the files are often difficult. When a search through this data is done, the resulting data set is often distributed among multiple locations, and there is a challenge to use the file-set efficiently. This is a universal problem for applications where content is stored in streams, and/or when the datasets are distributed, and/or very large. Files can be too big to be analyzed in their entirety, and they are hard to move across networks. It is also a challenge to find items of interest in a large set of files, using file based storage or even object based storage. The name of the file, or even the description of the file itself, as in object stores, does not say much about the internal contents of any specific frame, or interval inside the file. The same challenges also appears in multi-sensor systems where users want to access “snippets”, instances, or intervals, of a file or file-set, based on one, or a combination of several streams, content, or annotations about the content, inside the streams. Then the challenge arises of managing these data sets when they are defined. For example in Automotive Autonomous Drive applications, there may be 100 PByte or more (12,000 disks worth of data) distributed across the globe. Users need particular views of this data, some looking at traffic signs, other detecting bicyclists, and others looking at specific driving situations. Making copies of these datasets is costly, and guarantees of consistency are difficult. Finally when the dataset is defined, it is a challenge to actually use a very large number of instances of distributed data without rewriting the applications themselves. These are challenges are addressed by this invention.

Current approaches to create scalable storage systems for distributed data uses object-based storage systems such as CEPH and similar. These storage systems accesses “files and directories” based on meta-data about the files stored in a database. This database can be searched for where a particular set of files reside and then provide a “virtual” filesystem at that location. This is good for storage and access of items like pictures, movies, and user data, when the “file or directory” is what is important. Companies like Facebook, Spotify and Dropbox uses this type of scalable storage. These systems work well when data is relatively small and the unit of access is defined as a file or set of files. For accessing data based on internal content approaches vary, but they use either an index file located near the file of interest, or meta-data inside the files, or external databases that contain information about the files. None of these approaches provide a scalable and universal solution to the challenges addressed by this invention. The main problems are scalability, and no connection between the files and the annotations of the files. In other words, we might find the answers to where the data is, but it is not scalable in performance (takes longer when data grows) and the applications still must endeavor to retrieve the physical data by themselves.

The challenges for many applications of streaming big data in, for example, surveillance or measurement data applications, can include that the unit of interest is not the entire file or set of files, it is just one or many small portions of the file, and also that most files or file-set are too big to move. Thus, the file based traditional storage doesn't scale well, and the object based storage scales but doesn't find the content we are interested in, and the separation of annotation and data is not scalable for searches.

In this invention we can extend object based storage technology with concepts of annotations (tags) that designate properties inside a file or of a group of files or a computational result on files, which then points to locations in those files. Locations can be time, frame number, byte counter, or other information that can be used to find the appropriate position in the stream(s)/file(s). The location information can point to the whole file/group, an interval (start and end), or a specific instance (start equal end). The other properties of the TAG can describe what it process, e.g. “traffic sign, on the left hand side” or “pedestrian with backpack” and anything else that is relevant for that location or interval. Files can then be found by using a search for instances of “pedestrian” and “raining” and “city=Boston” and “year=2015” and “face=Joe_Smith”. In the proposed system this can return a set of instances (intervals) in all our files that had Joe Smith in Boston 2015 when it was raining. This concept can then produce a set of small files (without making copies) that corresponds to the instances found. We now can have access to just the parts that are of interest without scanning through large files or searching through files by hand.

The file based storage method can be extended with a notion of grouping of files (called Projects). Projects can be simply a set of files (file-set) that belong together and can be treated as a group. In a simple implementation this can be a physical directory and subdirectories on a traditional disk subsystem, but it can also be a set of files grouped by other process, such as relations in databases. Now a set of files can be operated on and used as a group. This process that operations “search” for content not only returns the file and location of interest, but the group of files that correspond to the project. This result is described in more detail below, and can be just a set of pointers to intervals of files in our distributed filesystem, no copies of any files are done, and no instances of the virtual files are needed before the resulting interval is actually accessed.

Extending the concept of files and groups; when operating on a group of files there are files that can be “cut” into smaller pieces and other files that can be exposed in their full content. This makes it possible to have descriptive files that are applicable to the project that can be exposed in full, while other files can be provided in CUT format based on the content search. This division can be made by, as a non-limiting example, file type or by a descriptor in the database (or together with the files in the project) for which files are to be left alone or cut by the filesystem.

As a further application of the concept, by keeping track of where the files physically resides, it can also be possible to instead of simply mounting the files to a machine (as disks or directories), send the application to the location where the files resides. The application can now execute where the data is, instead of moving the data. This system has many advantages, especially on distributed data sets where data is much bigger than the application, or when there are many instances of data that then can be operated on in parallel. In this case the system knows where (on which server) the file(s) reside, so it simply sends the application to that server (ftp, shared disk, or similar) then set up an EFS that points to the correct data, and (optionally) set up an appropriate virtual machine for the user application, mount the disks to a known location, and run the application. Results, log files and other auxiliary items can be treated in a similar way. In our sample embodiment we use the annotation concept (described later) to also store information about the application results as well as how it executed.

To increase scalability the annotation databases can be split according to the data sets they manage and potentially co-locate them with the data. By colocation of the databases (or simply splitting the databases) it is possible to provide a scalable system. Each time more “servers” are added to the system there are databases and consequently more compute performance added. To provide this scalability, the search for content can have an intermediate step, where the request for files can go to a master (or peer) server. This server can send the question to all other (or a selected set of) servers. The participating servers can perform a local search and send the results back to the requester. The requester can collect these results and produce the final results. In an embodiment described more fully below, a master (controller) node can be used to orchestrate the queries and execution, but it can also go from a master-slave system to a peer-to-peer system where any node can initiate searches on any other node.

In one embodiment the content addressable filesystem can consist of a database containing tags that designate locations and their meaning inside a file or a group of related files. This database can then be searched in order to find locations of areas of interest in the files under management. The search can be done either on a single tag (annotation) or a combination of multiple tags. The search can return a set of intervals in the files that correspond to the search criteria. An example of such interval would be “project=123” “time start=20160808-14234567” “time end=20160808-15000000” “server=WN0978” to designate a group of files and, in this case a start and end time of the files and the owner of those files. When the file is to be used the EF Scan create mount points for the requester that contain the files in the project, with designated files cut to the appropriate time interval and other files exposed in full. The user application can now use the files as a network mount point provided by the VFS.

The content addressable filesystem can extend the concept of an object store with a filesystem gateway to find and address content inside the files. Thus, by way of non-limiting examples, the unit of interest can be the presence of “Marilyn Monroe” in particular video frames in the all movies produced, or a scene in an autonomous drive data collection, where the radar detected a truck, while the camera detected a pedestrian, in Germany, when it was raining and there was a stop sign.

The system can consist of a database (or distributed set of databases) that contain information about the internal content of files and projects under control. A search engine can find instances and set of instances in the dataset based on search criteria provided to it. The results from the search can be provided to a virtual filesystem, or more commonly known as, a filesystem gateway, that can take the information project, start and end position and potentially translation information, and create a filesystem mount point for applications.

### Annotation Based Search

To address these challenges TAGs (also called annotations) can be defined as markers to events that point to an event (in the broadest possible sense) in a file or group of files. An example can be a Pedestrian from frame 10 to frame 100 in project ABC and file D.mp4. This in turn can be represented in a simple set of database tables. A TAG can have a reference to a file and/or a project and a process of defining a position in the same (for example a timestamp if the collection is based on time). A TAG can point to an entire project or file, a position, or an interval in a project or file. A TAG can represent just about anything and any number of TAG can be defined on instances or intervals in a project or projects. A TAG can have at least an identity and then 0 or more values and potentially other properties associated with it.

### Usage of TAG

A tag or annotation can signify anything of interest in a file or project. It can be a result of a computation on the project, on a group of files, or on content of the file itself. In general TAG can be defined as anything related to the project.

### Finding Instances of Data

To find instances of interest the tags are combined to form one or more search criteria. For example “Pedestrian and Rain >5 mm/h”. By combining tags, complex situations in the data can be found by simply combining the criteria and finding the intervals that correspond to them. One embodiment is to use a simple SQL database and use the capabilities of the database to find the appropriate intervals.

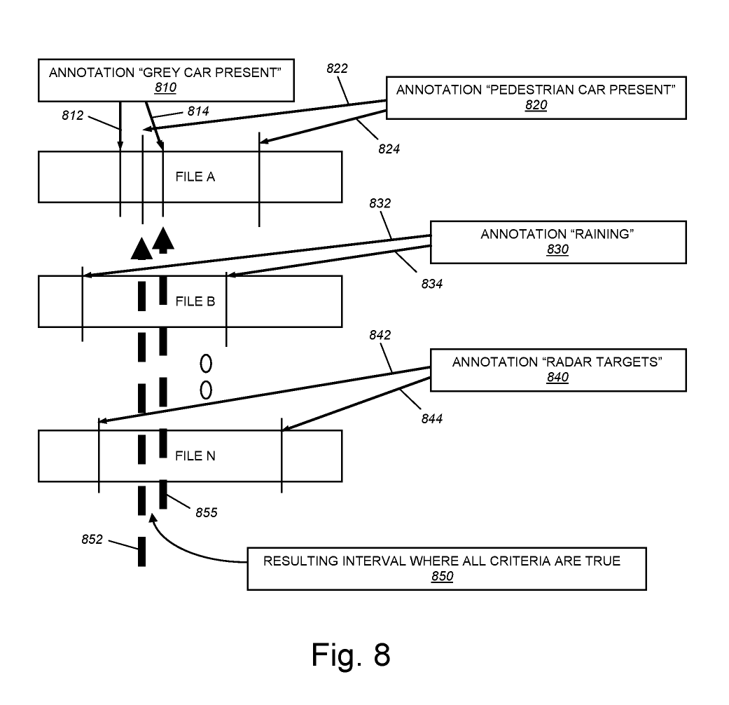

FIG. 8 is a block diagram showing how annotations based on intervals in a file or set of files can be used to come up with a final content addressed part of the file or set of files, according to an embodiment. A user can request data where the search criteria are true. By way of non-limiting example, a user can request data with a query for data that contains a grey car, contains a pedestrian, while it is raining, and with targets present in a radar stream. N different files are shown in FIG. 8, and the associated annotations can be searched as a group. Annotation 810 indicates that a grey car is present in the interval between 812 and 814 in File A. Annotation 820 indicates that a pedestrian is present in the interval between 822 and 824 in file A. Annotation 830 indicates that it is raining in the interval between 832 and 834 in File B. Annotation 840 indicates that there are radar targets in the interval between 842 and 844 in File N. These intervals can be combined to create the resulting interval 850 where all criteria are true. The resulting interval 850 where all criteria are true is shown as the interval between 852 and 854. The resulting interval 850 where all criteria are true can indicate the resulting file set interval that the user is viewing. The results from the search can be provided to a virtual filesystem, or more commonly known as a filesystem gateway, that can take the information project and the resulting interval 850, and can create a filesystem mount point for applications.

### Scalability of Search

By splitting the databases along projects, the search can be done in parallel by simply using an intermediate stage where a question can get sent to many databases and then the results can be collected from these individual searches in order to form a global result.

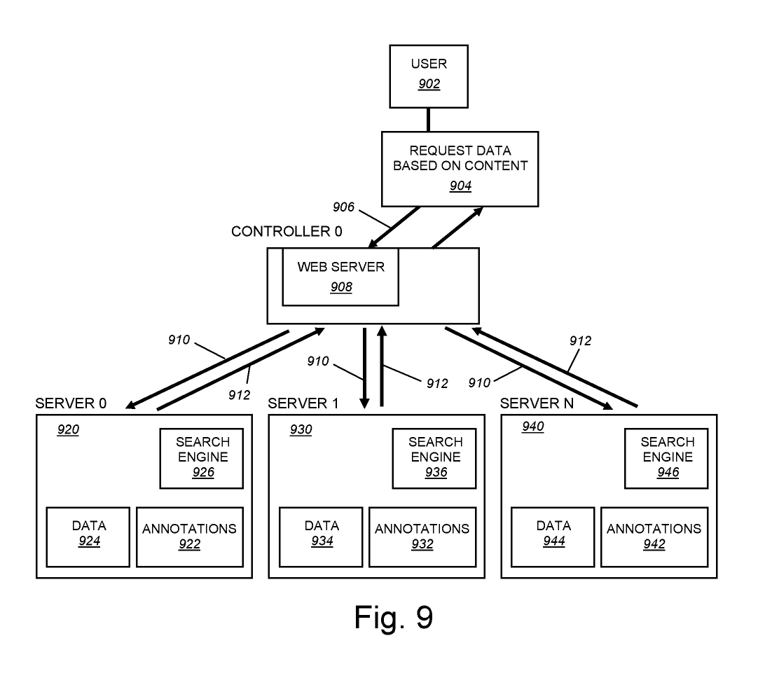

FIG. 9 is a block diagram showing a distributed search for content addressable filesystem, according to an embodiment. A user 902 can enter a request for set of data based on content 904. The request 904 can be transmitted 906 to a controller 908 (or a peer server), that can process the request and transmit 910 the request 904 to the participating servers 920, 930, and 940. These servers store annotations (TAG) 922, 932, and 944, about the stored data(sets) 924, 934, 944, and have search engines (algorithms) 926, 936, and 946 that can search the database content for intervals as described above in relation to FIG. 8. Each server 920, 930 and 940 can find local matching data. These results (e.g. pointers to matching intervals) can be transmitted 912 to the controller (or peer) 908. The controller (or peer) 908 can consolidate all of these results and present 914 the consolidated answers to the user 902. Notably the servers can be distributed across many networks and do not have to be collocated. Nodes can be anywhere as long as they are accessible by a communication protocol from the requester.

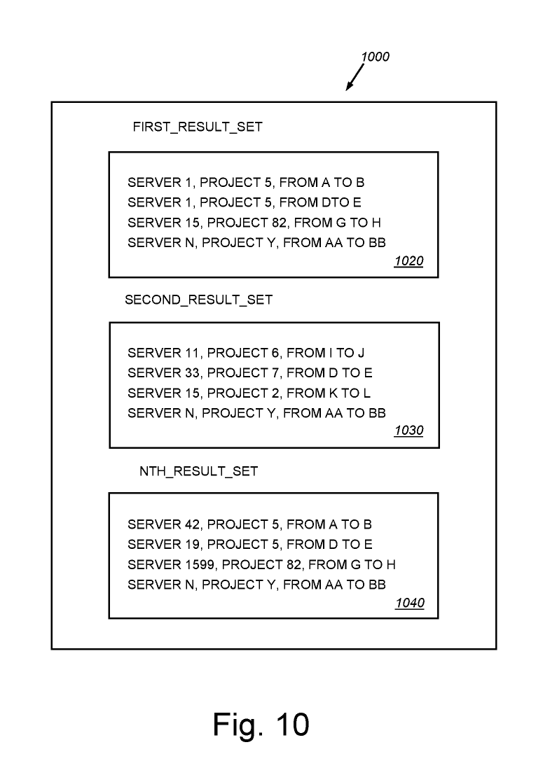

FIG. 10 is a diagram showing an example of result sets of the distributed search of FIG. 9, according to an embodiment. The exemplary consolidated result set 1000 can include result set 1020 that can be, for example, from server 920, result set 1030 that can be, for example, from server 1030, and result set 1040 that can be, for example, from server 940. Each result-set 1020, 1030, and 1040 can define a set of data with locations of files and intervals of interest by pointers to data pointing to server, project and interval. These results can later be used in conjunction with the virtual filesystem to only create the “file-intervals” when somebody actually uses it. This system can remove the need for copies of data when creating subsets, and can allow for a large number of subsets to be created without making any actual copies of the files. The result set will be consistent when shared as no copies of the files are made. More particularly, FIG. 10 depicts file descriptions as returned by a content addressable search. This is the form that the virtual files have before and/or until they are actually used. These files can be characterized by massive data sets, but only the original is actually stored. Thus, an indefinite number of different data subsets can exist relative to the massive original data set without (free of) any copies. These subsets can exist in various discrete and differing in multiple different file formats, while no space is used until a particular file is accessed.

Colocation of Annotation with Data

By locating the annotations with the data itself, it is possible to improve performance, and also enable local use of individual tags in applications. Using databases located with the data can also enable small implementations and massively parallel search capabilities.

Filesystem implementation can, for example, use a FUSE filesystem to provide the mount points for the user side, and use a custom set of file readers and translations in the FUSE layer.

### Filesystem Implementation

By using the annotation data from the search, a filesystem mount point can now be created. In one embodiment, the actual group of files can be provided as a disk/mount point for the user. The files can now be simply a directory that can be used as a regular filesystem.

Extending the Concept with a Translating Filesystem:

Using the result from the search, containing the pointers to the project or file(s) including the start and end points requested, it is possible to use the VFS to create a set of virtual files that are just exposing the parts of interest of the original files on disk. In this implementation the original file can be transformed from the original length and format to the requested interval. This can be accomplished by setting up an EFS with the appropriate readers and formatters for the file(s) in question to provide the new file content. Note that many files can be cut at the appropriate location and provided, where others such as MPEG files may need to be translated with the correct headers and descriptors. To do this the filesystem may need to know about the formats to appropriately cut them.

### Sending the Applications to the Data:

Since the filesystem knows where the data resides, and provides the mount points to the applications, it is possible to use that information and send the application to the data and execute it on the server (or near) the server that has the data.

By using a data-set that points to intervals in projects on specific servers (or locations) and combining that with a virtual machine concept, it is possible to use the data-set as a base for where the applications should run, send the applications to that location (automatically), create a virtual machine for the application, and execute the applications locally. By doing this it is possible to accelerate regular desktop applications to run on thousands of machines in parallel, without changing the applications or having the user create complex script to do it.

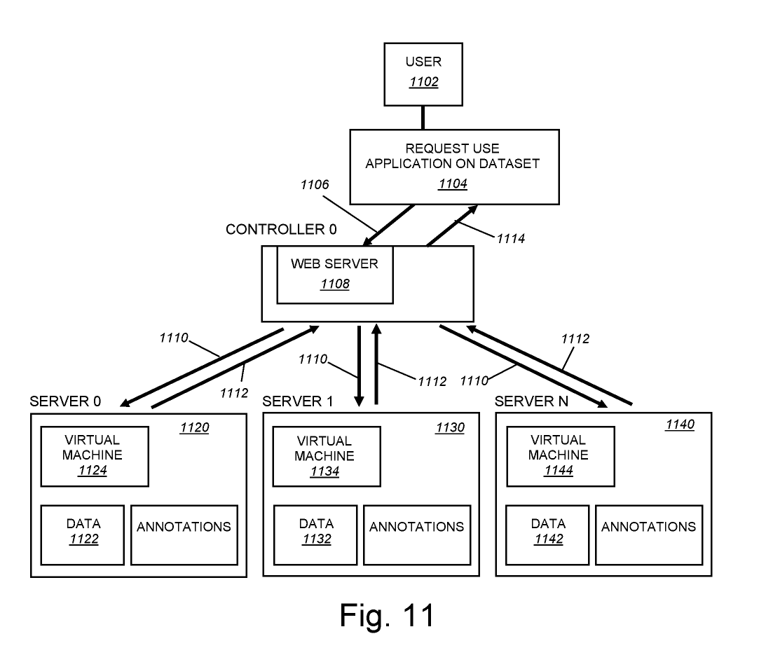

FIG. 11 is a block diagram showing an example of how the result sets of FIG. 10 are used in a distributed global setting, according to an embodiment. The user 1102 can select a result-set (similar to FIG. 10) and can enter a request 1104 for the system to apply applications to that dataset. The request 1104 can be transmitted 1106 to a controller (or peer server) 1108. The controller 1108 can then transmit 1110 the required information (application and parameters) to the servers 1120, 1130, and 1140 containing the instances of the data set, where the application can be executed on the local data. The servers 1120, 1130, and 1140 can each use a virtual machine 1124, 1134, and 1144 to execute the application on the local data 1122, 1132, and 1142 in parallel. Using this system the local data may not need to be moved and regular desktop applications can be used without rewriting them for parallel execution. The applications can generate virtual files that can be transmitted 1112 to the controller 1108. The controller can transmit 1114 the virtual files to the user 1102.

### Conclusion

The above-described arrangement and associated processes provide an effective way to organize and selectively access large files and mass quantities of data in a storage environment, which generally comprises a global distributed content addressable filesystem. Generally, the process provides annotations (tags) that point to frames or intervals in the stored data. In the example of the above-referenced U.S. patent application Ser. No. 13/625,553, in the context of autonomous vehicle telemetry, there can be data sources from six exemplary cameras (two cameras forward and four other cameras providing views around the vehicle); four exemplary radars; one large-scale LIDAR; ten (e.g.) additional sensors; and potentially four or more smaller-scale LIDAR's. Each of these data streams includes added tags—for example, camera 2 views a pedestrian between 10 AM and 10:01 AM, the large LIDAR had targets at different positions at the same time, and so on. Each data stream is large, but all these streams relate to each other (e.g. have the same time base). This is similar to an exemplary sporting event where dozens of different cameras and audio feeds all view the same overall event, and thus are related in space and time. In the embodiments herein, each stream is annotated (tagged), and the annotations are related to each other in time (i.e. they view the same event). Thus, when a user wishes to access/view the stored data, he/she wishes to access the “snippet” of Video and Audio from ALL the cameras and audio streams from the time corresponding to my SEARCH criteria. In a football game context, assume (by way of example) that the Patriots are playing Seahawks in a game where Coach Bellicheck is not wearing cut-off shirt, and Brady fumbles the ball. It would be low and cumbersome to addresses the data by Sunday football video feeds, and then scan by hand through all feeds to find these intervals. Rather, according to the illustrative embodiment, data files are addressed by content, whereby ‘Brady fumbles with Bellicheck in long sleeves playing the Seahawks’. This is the fundamental organization of data in accordance with the illustrative system and method.

In the context of the vehicle example, the interval of interest is the same (the user wishes to view/access what is going on in the vehicle from Time A to Time B). The camera data streams from the forward vehicle camera might require a different filter or translator from those viewing the vehicle sides, although they happen to all have the same stored data format. An illustrative configuration file (or a dynamic API, etc.) is used to handle such data (tells the translators what to do), including the set up of appropriate output files. Advantageously, the illustrative Content Addressability embodiment scales across global networks of storage systems. By using the Pointers To Data (sets) and only “create” the files Virtual Copies, of the data sets, and in fact, only the files that are used contemporaneously with their actual use, affords the ability to have a virtually infinite number of different subsets of the original dataset without (free of) actually increasing storage needs. This is a highly advantageous outcome in that it avoids the need to make copies of (e.g.) “Brady snippets” then copies of “Brady and Manning” snippets, and so on. Alternatively, as a practical matter, when the data grows large, such a fragmented snippet approach would be prohibitive.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present invention, what has been described herein is merely illustrative of the application of the principles of the present invention. Also, as used herein various directional and orientational terms (and grammatical variations thereof) such as “vertical”, “horizontal”, “up”, “down”, “bottom”, “top”, “side”, “front”, “rear”, “left”, “right”, “forward”, “rearward”, and the like, are used only as relative conventions and not as absolute orientations with respect to a fixed coordinate system, such as the acting direction of gravity. Moreover, a depicted process or processor can be combined with other processes and/or processors or divided into various sub-processes or processors. Such sub-processes and/or sub-processors can be variously combined according to embodiments herein. Likewise, it is expressly contemplated that any function, process and/or processor herein can be implemented using electronic hardware, software consisting of a non-transitory computer-readable medium of program instructions, or a combination of hardware and software. Accordingly, this description is meant to be taken only by way of example, and not to otherwise limit the scope of this invention.

What is claimed is:

1. File system for organizing files in a data processing and handling device comprising:
a set of annotations signifying locations or time in files;
a search process that combines annotations and intervals together into a final result; and
a user interface operatively connected to the device that allows the user to enter requests and data;
wherein the user requests the intervals in files that corresponds to one or more search criteria and the search process searches through the annotations and combines them to find the intervals in files or groups of files where the condition is true, and the intervals of the found files are arranged to be displayed to the user on the interface.

2. The file system as set forth in claim 1 wherein the data processing and handling device comprises a distributed content addressable storage arrangement.

3. The file system as set forth in claim 2 wherein the storage arrangement comprises a plurality of storage servers.

4. The file system as set forth in claim 3 wherein each of the storage servers is constructed and arranged to perform a data distribution and collection function, wherein the data distribution function receives the request from the user that it distributes to participating storage nodes, wherein the storage nodes search for the results with the search process and return the results to the collection function, in which the results are presented to the user via the user interface.

5. The system as set forth in claim 1 wherein the files displayed are separated from the format they are stored in components that the translation layer knows about certain file types and can translate from one type of file to another type of file, and wherein the translation is performed using a fixed translation scheme

6. The system as set forth in claim 5 wherein the files stored in a first format (A) are presented to the user in a second format (B).

7. The system as set forth in claim 1, wherein where the files are presented as a subset of the original file and translated or transformed to be a valid file comprising of the subset requested in the same or a different format or formats further comprising;
(a) components and a process for determining the start and end of the subset of the files or sets of files where a start and end index, time, location, marker or other process are defined by an outside process,
(b) translation layer reads the original file(s) and creates a new virtual file based on this information, and
(c) the virtual file is a window and not the whole file, whereby the user is presented with a smaller virtual copy of the original file or files comprising of the interval requested, and whereby the whole files and their format need not be known, or moved, and they are protected from the user.

8. The system as set forth in claim 7 wherein the system is arranged to cut a file and then present a virtual smaller file to the user comprising;
(a) original files on stored media,
(b) a reader and translation layer that knows how to read write and access the original files,
(c) a process of transforming the portion of the file into a new valid smaller (shorter) and/or different file,
(d) a presentation filesystem that the user can access to the new virtual file, wherein the original files are protected and hidden from the user and the user can work on only a particular portion of the files in potentially in different file formats enabling the user application to work independent of the stored format as well as only on portions of the actual files.

9. A system for accessing as a file a resulting file derived from a one or plurality of other files in which more than one file is used to produce an output file that the user can view comprising:
one or more storage devices that contain(s) the files used to construct the requested file;
a software layer that can concatenate, combine and/or translate the file into the appropriate format for the end application; and
a user filesystem presentation layer that presents the resulting file to the user where this layer can be, but not limited to FUSE, wherein the user operates on a derived file based on one or more concatenated or combined files leaving original data on the storage system.

10. The system as set forth in claim 9 wherein the stored files are of a controller area network (CAN bus) type, and one or more of the files contain the CAN database data describing what the messages mean and the system provides as an output the combined and decoded CAN messages to the application whereby the application is free of knowledge as to how to translate and filter the CAN messages and as to the format they are stored in.

11. The system as set forth in claim 10 wherein the application comprises a commercially available package.

12. A system for accessing portions of files or file sets based on intervals determined by an outside process comprising:
original files on a storage system;
a translator that can cut files of known types based on an interval criteria,
wherein the translator has knowledge as to how to read an appropriate interval of data from the original files.

13. The system as set forth in claim 12 wherein the translator can recreate a new, potentially smaller file with the appropriate header information based on the requested file format and interval.

14. The system as set forth in claim 12 wherein the translator is arranged to combine a plurality of files into the resulting file.

15. The system as set forth in claim 12 wherein the translator is arranged to output a plurality of different formats concurrently.

16. The system as set forth in claim 12, further comprising a process of inputting to the translation layer the interval of interest for example start and end time of a recording.

17. The system as set forth in claim 12, further comprising a presentation layer that presents the resulting file-system, file or file-set to the user, wherein the user layer software views a set of files containing only the area of interest and in the formats requested enabling greater efficiency and standard applications to be used.

18. A system for accessing files stored on a computer filesystem separated from the stored files and accessed in one or a plurality of discrete formats that can differ from the stored format comprising:
a filesystem interface for access of the file;
a translation layer that separates the stored files from the presented files; and
a set of files stored on a media local or remote storage system that is managed by the translation layer to be combined, concatenated, translated or in any other process modified or buffered before the resulting file(s) is shown to the user filesystem, wherein the files are presented to a user in a predetermined format as a combination, concatenation, or passed through by the translation layer software, and thereby creating a separation of stored files and presented files for an application enabling cutting, translation and concatenation before the user accesses the file.
